(19) United States
(12) Patent Application Publication
(10) Pub. No.: US 2013/0120458 A1
(43) Pub. Date: May 16, 2013

(54) DETECTING SCREEN ORIENTATION BY USING ONE OR MORE PROXIMITY SENSORS

(71) Applicants: Berk C. Celebisoy, Seattle, WA (US); Jennifer Anne Karr, Edmonds, WA (US)

(72) Inventors: Berk C. Celebisoy, Seattle, WA (US); Jennifer Anne Karr, Edmonds, WA (US)

(73) Assignee: Microsoft Corporation, Redmond, WA (US)

(21) Appl. No.: 13/298,069

(22) Filed: Nov. 16, 2011

(51) Int. Cl. G09G 5/00

(52) U.S. Cl. 345/649; 345/619

(57) ABSTRACT

Techniques and tools are described for detecting screen orientation using proximity sensors. A display mode of an electronic display of a mobile device can be changed based on input from one or more proximity sensors. The display mode can be changed to a portrait, a landscape mode, or other display mode based on the input from the one or more proximity sensors. In one embodiment, the input can indicate that one or more objects are proximate to or in physical contact with a perimeter of a front surface of the mobile device. In another embodiment, the input can indicate that the one or more objects are proximate to or in physical contact with a portion of the mobile device, such as a side surface.

### FIELD

This application relates to detection of screen orientation, and, in particular, detection of screen orientation for a mobile device by using one or more proximity sensors.

### BACKGROUND

Mobile devices often include a display screen (i.e., an electronic display) to facilitate user interaction with the device. It is generally desirable that the content or information (e.g., text or graphics) displayed on the screen be oriented properly for the user. For example, if the screen is displaying text, the text should be oriented such that the user can easily read it from his/her vantage point. That is, the text should be oriented such that the top of the display screen corresponds to the top of the displayed text from that user's perspective. However, because the device—and therefore the screen—can be rotated and oriented in various ways, information is not always properly oriented for viewing by the user. Thus, it is desirable for the orientation of the displayed content to be able to change and adapt as the user moves the device.

Conventional mobile devices use an accelerometer such as a gravity sensor to control the orientation of the displayed content. That is, the accelerometer detects changes in the orientation of the mobile device, and the information displayed is rotated in response to the detected changes. For example, if the device is rotated clockwise by the user, the accelerometer detects the rotation and the information displayed is rotated counterclockwise to maintain the same orientation relative to the user. Data from the accelerometer thereby controls the display orientation for the device.

Accelerometers can, however, result in display rotation or orientation that is not proper for viewing by the user or that is unintended by the user.

### SUMMARY

Described below are techniques and tools for detecting screen orientation by using one or more proximity sensors that address some of the shortcomings of conventional devices. For example, using one or more proximity sensors to detect screen orientation can reduce unintended display rotation. One advantage is that the manner in which a user holds a device can be used to determine a display mode of the device.

In one embodiment, a mobile device comprises one or more proximity sensors configured to detect whether an object is proximate to the sensor. In some examples, the one or more proximity sensors are located on a side surface of the device, while in other examples the sensors are located near to a front surface of the device. The mobile device also comprises a display screen on its front surface, and the display mode of the screen is changed based on whether or not one or more of the proximity sensors detects an object. That is, the one or more proximity sensors are located on the device so as to detect screen orientation. For example, the proximity sensors can be located to detect common ways in which a user could hold or position the device, and the device can be configured to change the display mode such that the display is oriented as intended by the user.

This summary is provided to introduce a selection of concepts in a simplified form that is further described below in the detailed description. This summary is not intended to identify key features or essential features of the claimed subject matter, nor is it intended to be used to limit the scope of the claimed subject matter.

The foregoing and additional features and advantages will become more apparent from the following detailed description, which proceeds with reference to the accompanying figures.

### BRIEF DESCRIPTION OF THE DRAWINGS

FIG. 1 is a detailed block diagram illustrating an example mobile computing device in conjunction with which techniques and tools described herein may be implemented.

FIG. 2 is a block diagram illustrating an example mobile computing device configured to detect screen orientation using one or more proximity sensors.

FIG. 3 is a diagram of an exemplary system for implementing detection of screen orientation using one or more proximity sensors.

FIG. 4 is a diagram of an exemplary device having proximity sensors and capable of implementing techniques and tools described herein.

FIGS. 5A-5C are diagrams illustrating example embodiments of a mobile device configured to detect screen orientation by using one or more proximity sensors.

FIGS. 6A-6B are diagrams illustrating an example embodiments of a mobile device configured to detect screen orientation by using one or more proximity sensors.

FIG. 7 is a diagram of an exemplary mobile device having proximity sensors and capable of implementing techniques and tools described herein.

FIG. 8 is a flowchart of an exemplary method of detecting screen orientation by using proximity sensors.

FIG. 9 is a flowchart of an exemplary method of changing the display mode of an electronic display of a mobile device.

FIG. 10 illustrates a generalized example of a suitable implementation environment in which described embodiments, techniques, and technologies may be implemented.

### DETAILED DESCRIPTION

### Example 1

### Exemplary Mobile Computing Device

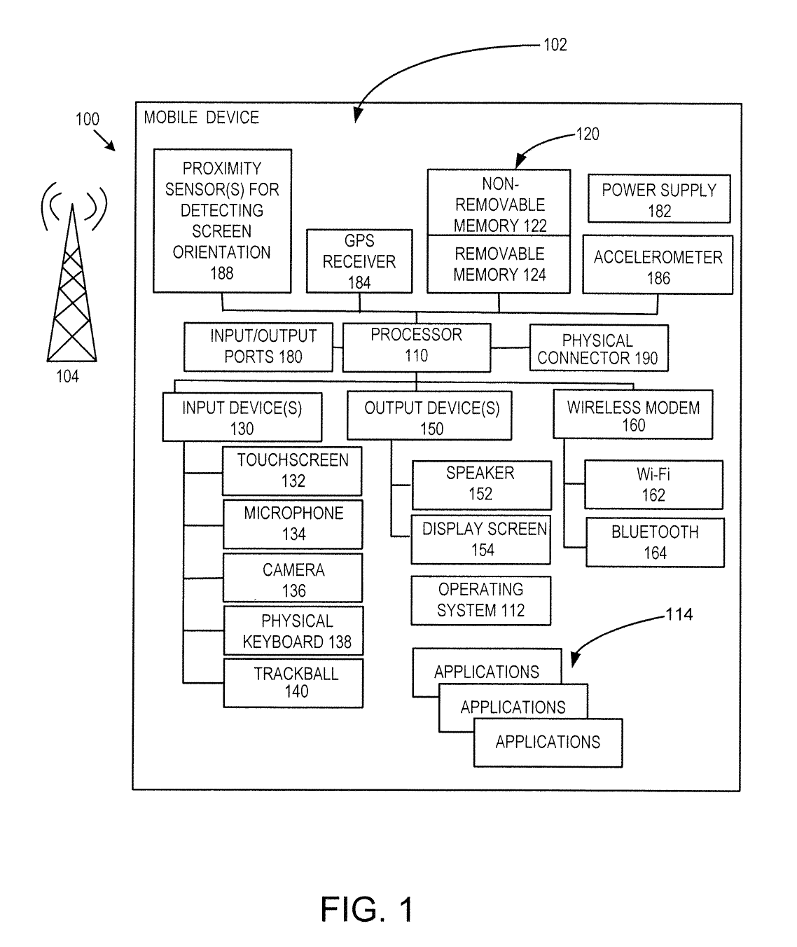

FIG. 1 is a detailed diagram depicting an exemplary mobile computing device 100 capable of implementing the techniques and solutions described herein. The mobile device 100 includes a variety of optional hardware and software components, shown generally at 102. In general, any component 102 in the mobile device can communicate with any other component in the mobile device, although not all connections are shown for ease of illustration. The mobile device can be any of a variety of computing devices (e.g., cell phone, smartphone, handheld computer, laptop computer, notebook computer, tablet device, netbook, media player, Personal Digital Assistant (PDA), camera, video camera, etc.) and can allow wireless two-way communications with one or more mobile communications networks 104, such as a Wi-Fi, cellular or satellite network.

The illustrated mobile device 100 can include a controller or processor 110 (e.g., signal processor, microprocessor, ASIC, or other control and processing logic circuitry) for performing such tasks as signal coding, data processing, input/output processing, power control, and/or other functions. An operating system 112 can control the allocation and usage of the components 102 and support for one or more application programs 114. The application programs can include common mobile computing applications (e.g., email applications, calendars, contact managers, web browsers, messaging applications), or any other computing application.

The illustrated mobile device 100 can include memory 120. Memory 120 can include non-removable memory 122 and/or removable memory 124. The non-removable memory 122 can include RAM, ROM, flash memory, a hard disk, or other well-known memory storage technologies. The removable memory 124 can include flash memory or a Subscriber Identity Module (SIM) card, which is well known in GSM communication systems, or other well-known memory storage technologies, such as “smart cards.” The memory 120 can be used for storing data and/or code for running the operating system 112 and the applications 114. Example data can include web pages, text, images, sound files, video data, or other data sets to be sent to and/or received from one or more network servers or other devices via one or more wired or wireless networks. The memory 120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 100 can support one or more input devices 130, such as a touchscreen 132 (e.g., capable of capturing finger tap inputs, finger gesture inputs, or keystroke inputs for a virtual keyboard or keypad), microphone 134, camera 136, physical keyboard 138 and/or trackball 140 and one or more output devices 150, such as a speaker 152 and a display screen (i.e., electronic display) 154. Other possible output devices (not shown) can include piezoelectric or other haptic output devices. Some devices can serve more than one input/output function. For example, touchscreen 132 and screen 154 can be combined in a single input/output device.

A wireless modem 160 can be coupled to one or more antennas (not shown) and can support two-way communications between the processor 110 and external devices, as is well understood in the art. The modem 160 is shown generically and can include a cellular modem for communicating at long range with the mobile communication network 104, a Bluetooth-compatible modem 164, or a Wi-Fi compatible modem 162 for communicating at short range with an external Bluetooth-equipped device or a local wireless data network or router. The wireless modem 160 is typically configured for communication with one or more cellular networks, such as a GSM network for data and voice communications within a single cellular network, between cellular networks, or between the mobile device and a public switched telephone network (PSTN).

The mobile device 100 supports at least one proximity sensor 188 for detecting the orientation of the display screen 154 using tools and techniques described herein. For example, the proximity sensor 188 can be configured to provide the operating system 112 with input regarding whether an object is proximate to the proximity sensor 188. In response, the operating system 112 can change the display mode of the screen 154. The mobile device 100 can include one or more proximity sensors in addition to proximity sensor 188 for use with other functions of the mobile device besides detecting screen orientation. The mobile device can support an optional accelerometer 186, such as a gravity sensor. The mobile device can be configured to detect orientation of the display screen 154 using the proximity sensor 188 in addition to or instead of the accelerometer 186. For example, the operating system 112 can change the display mode of the screen 154 based on information received from both the proximity sensor 188 and accelerometer 186.

The mobile device can further include at least one input/output port 180, a power supply 182, a satellite navigation system receiver 184, such as a Global Positioning System (GPS) receiver, and/or a physical connector 190, which can be a USB port, IEEE 1394 (FireWire) port, and/or RS-232 port. The illustrated components 102 are not all required or all-inclusive, as the components shown can be deleted and other components can be added.

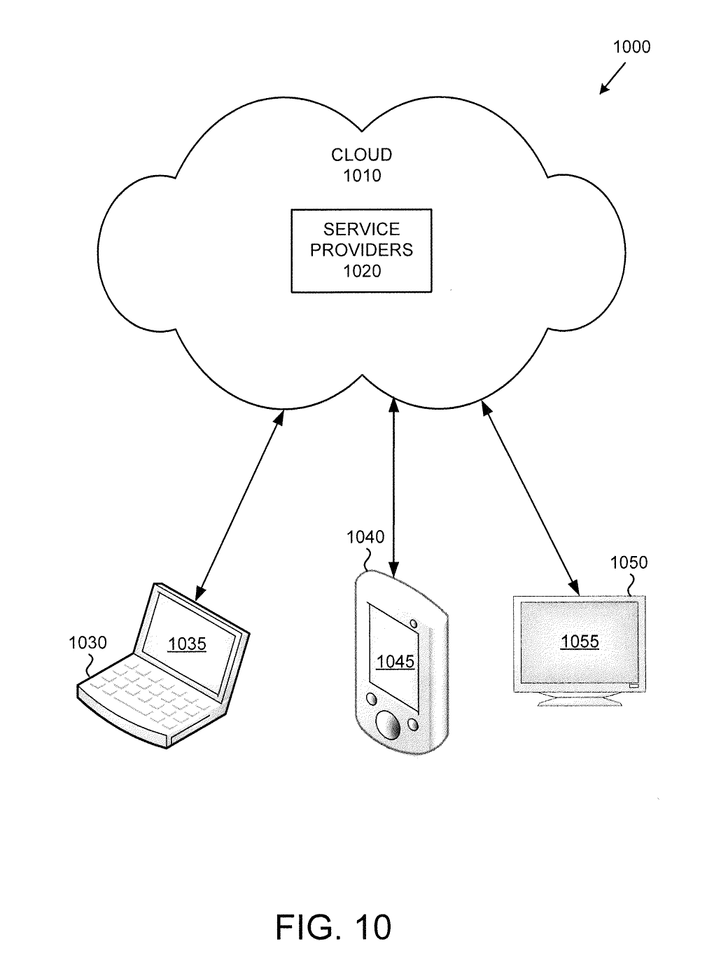

The mobile device 100 can be part of an implementation environment in which various types of services (e.g., computing services) are provided by a computing “cloud” (see, for example, FIG. 10).

### Example 2

### Exemplary Proximity Sensors

As described herein, proximity sensors can be used to detect screen orientation of a mobile device. Such proximity sensors can be any proximity sensor known in the art. In general, a proximity sensor is capable of sensing the proximity of an object to the sensor. That is, such sensors can detect the presence of an object without physical contact. However, as used herein, proximity sensors can either alternatively or additionally sense the presence of an object based on physical contact. Example proximity sensors can be inductive, capacitive, optical, acoustic, photoelectric, or magnetic proximity sensors, or proximity sensors can use capacitive, resistive, or other touchscreen technologies. In one implementation, proximity sensors can be infrared (IR) sensors that emit IR light and detect reflected IR light in order to sense proximity of an object.

Proximity sensors can be capable of sensing various objects. For example, the object sensed can be a person or a part of a person (e.g., a hand) or the object can be non-human (e.g., a table or other object). The sensed object may or may not be in physical contact with the proximity sensor or with a surface of the mobile device associated with the sensor. Typically, the sensed object is within 2 inches of the mobile device surface or the proximity sensor. However, proximity sensors can be configured to detect objects within only 0.5 inches, within 1 inch, or within 1.5 inches.

Proximity sensors described herein can be used in addition to or instead of an accelerometer to detect screen orientation and control display mode. If proximity sensors are used in addition to an accelerometer, either can be set as a default. For example, proximity sensors can override accelerometer signals in all or in certain circumstances, such as when in conflict. However, mobile devices can be configured to use only proximity sensors to detect screen orientation and to control display mode.

### Example 3

### Exemplary Mobile Computing Device with Proximity Sensors

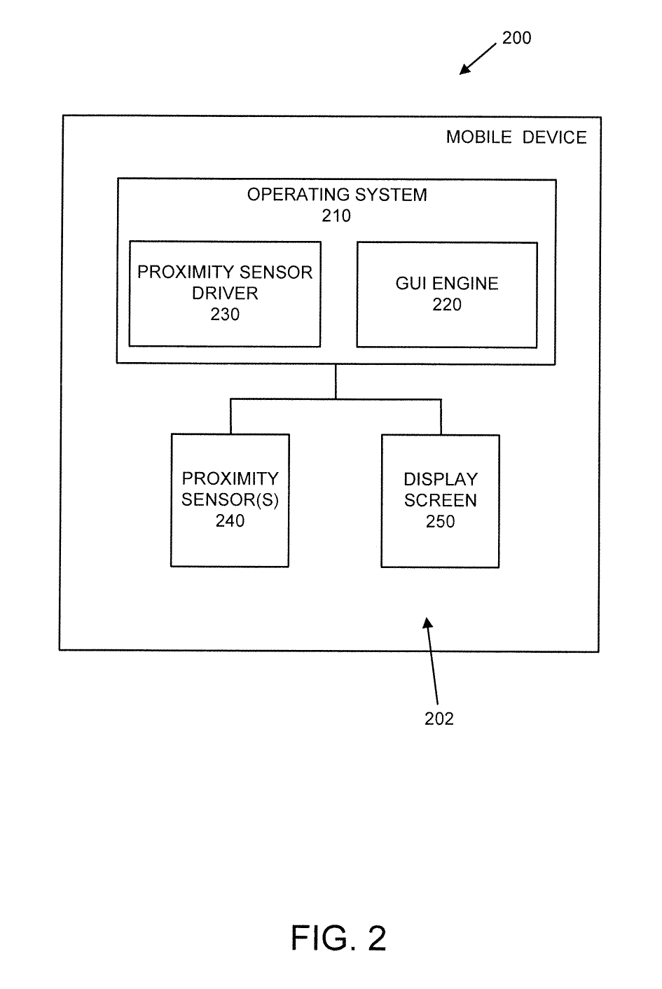

FIG. 2 is a block diagram illustrating an example mobile computing device 200 configured to detect the orientation of a display screen 250 using one or more proximity sensors 240. The device 200 can be configured to implement tools and techniques described herein. Referring to the figure, the mobile device 200 includes an operating system 210 in communication with the proximity sensors 240. For purposes of illustration, the operating system 210 is shown to include a proximity sensor driver 230 and a GUI engine 220. The GUI engine 220 can be a user interface engine or other similar engine. However, the operating system 210 can include additional software, and may or may not include the GUI engine 220. Further, the proximity sensor driver 230 can be software separate from the operating system 210. The mobile device 200 can include more components than the illustrated components 202.

Referring to FIG. 2, the proximity sensors 240 detect the proximity of objects to the mobile device 200 and can communicate this information to the operating system 210, such as via the proximity sensor driver 230. The operating system 210 controls the display screen 250, such as via the GUI engine 220. Specifically, the operating system 210 controls the orientation of the information displayed on the screen 250, which is referred to herein as the display mode of the screen 250. The display screen 250 can be configured to display information in at least a portrait mode and a landscape mode. The operating system 210 controls the display mode of the screen 250 based on information received from the proximity sensors 240.

### Example 4

### Exemplary System for Detecting Screen Orientation Using Proximity Sensors

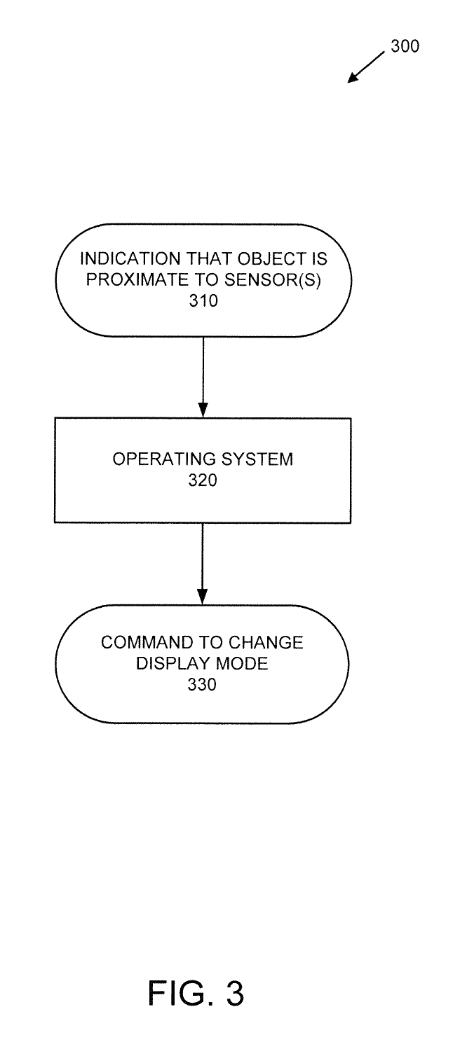

FIG. 3 is a diagram of an exemplary system 300 for implementing detection of screen orientation using one or more proximity sensors. The system 300 can be implemented as part of any mobile device described herein. In the example, an indication 310 that an object is proximate to a proximity sensor is received by an operating system 320. The indication 310 can be any input, such as a message or other signal. The indication 310 can be a signal from one or more proximity sensors, or the indication 310 can be a signal from a proximity sensor driver. Further, the indication 310 can be in response to one or more requests for information made by the operating system 320, by a proximity sensor driver, or by another application. In general, the indication 310 informs the operating system 320 that an object is proximate to one or more proximity sensors.

The operating system 320 processes the input 310 and can determine the orientation of a display screen, or electronic display, associated with the system 300. Based on the received indication 310, the operating system 320 issues a command 330 to change the display mode of the associated display screen. Exemplary display modes include a portrait mode and a landscape mode as described herein. However, a display mode can be any other orientation of the displayed content. For example, multiple display modes can be defined based on incremental rotations from a reference mode, such as four display modes defined at 0°, 90°, 180°, and 270° of rotation, or six display modes defined at 0°, 60°, 120°, 180°, 240°, and 300° of rotation.

In some embodiments described herein, the indication 310 can be from a first proximity sensor(s), and the operating system 320 can also receive an indication that an object is not proximate to a second proximity sensor(s). That is, lack of detection of an object by the second proximity sensor(s) (e.g., an object is not being detected proximate to that sensor) can also be considered input. For example, if a proximity sensor is not providing an indication that an object is proximate to the proximity sensor, this is an indication that an object is not proximate to that proximity sensor. In these embodiments, the command 330 to change the display mode of the display screen is based on both the indication from the first proximity sensor(s) and the indication from the second proximity sensor(s).

In practice, the system 300 can be more complicated, with additional inputs, outputs and the like.

### Example 5

### Exemplary Mobile Device with Proximity Sensors

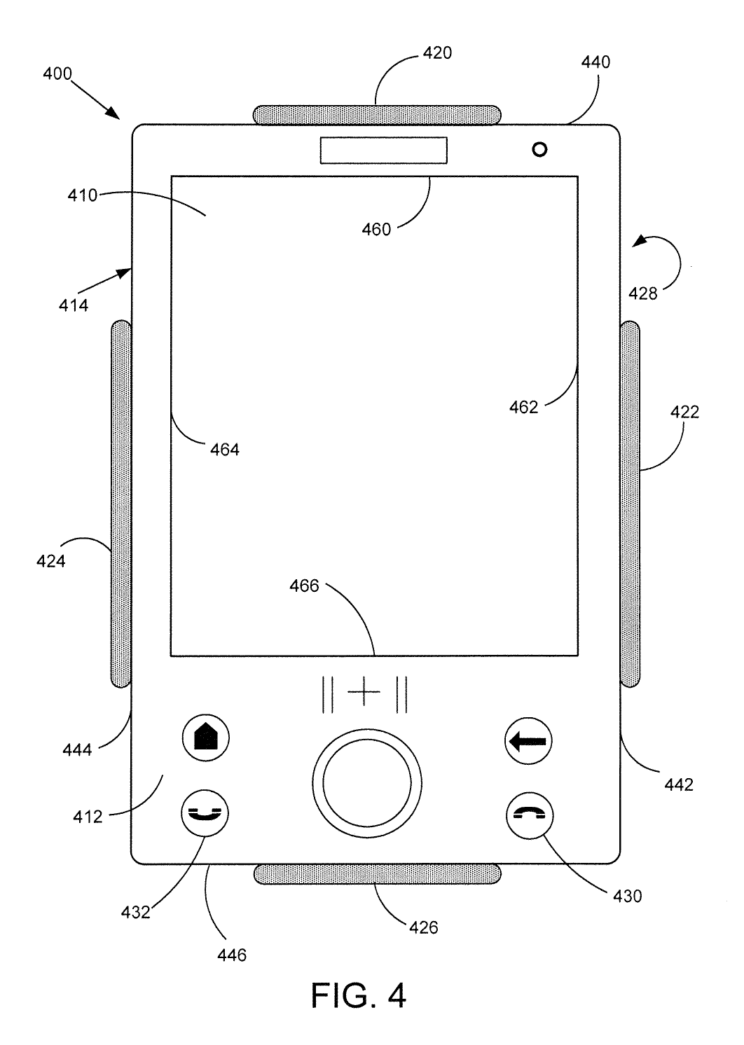

FIG. 4 illustrates an example mobile device 400 capable of implementing tools and techniques described herein. Mobile device 400 has a display screen 410 on its front surface 412 for displaying content (e.g., text or graphics) and several buttons 430, 432 for facilitating user interaction with the device. The mobile device 400 also has sensing regions 420, 422, 424, 426 positioned along a perimeter 414 of the front surface 412. The regions 420, 422, 424, 426 each represent the sensing region of one or more proximity sensors included in the mobile device 400. Thus, the regions 420, 422, 424, 426 are referred to herein generally as proximity sensors 420, 422, 424, 426.

The proximity sensors 420, 422, 424, 426 are shown to have a particular size for purposes of illustration, however, the sensors can be smaller or larger. In addition, each of the sensors can be divided into multiple regions, and positioned differently along the perimeter 414. For example, each of the sensors 420, 422, 424, 426 are shown to have a length that is approximately one half the length of each of the edges 440, 442, 444, 446, respectively. However, the sensors can be longer, having lengths approximately equal to the edge length, three fourths of the edge length, or other fraction of the edge length. Further, the sensors can be shorter, having lengths less than one half the edge length, such as approximately one third, one quarter, one eighth, one sixteenth, or less of the edge length. For example, the sensors can be small approximately circular sensors each having a diameter of less than approximately one twentieth of the edge length. Likewise, the sensors 420, 422, 424, 426 are shown centered on the respective edges (i.e., the center of the sensor is at the approximate center of the respective edge). However, sensors can be positioned closer to the corners of the device 400. Further, two or more proximity sensors can be positioned along a single edge. For example, one or more of the sensors 420, 422, 424, 426 can be a series of small approximately circular sensors spaced from each other along the respective edge.

Further, the mobile device 400 can have fewer or more proximity sensors, or it can have any combination of the proximity sensors 420, 422, 424, 426. For example, the mobile device 400 can have a proximity sensor 428 on a back surface in addition to or instead of other proximity sensors. Further, the mobile device 400 can have only a pair of sensors, such as sensor 420 and sensor 426, sensor 422 and sensor 424, or any other combination.

Although the sensors 420, 422, 424, 426 are shown to be in contact with the perimeter 414, such contact is not required. In general, the sensors 420, 422, 424, 426 are part of the mobile device 400 and situated such that objects proximate to the perimeter can be sensed by the proximity sensors. For example, sensor 420 can be positioned so as to detect objects proximate to the edge 440, sensor 422 can be positioned so as to detect objects proximate to the edge 442, sensor 424 can be positioned so as to detect objects proximate to the edge 444, and sensor 426 can be positioned so as to detect objects proximate to the edge 446. In addition, two or more proximity sensors can be positioned along a single edge, so as to detect objects proximate to that edge. In some embodiments, one or more of the sensors 420, 422, 424, 426 can be configured to discern the portion of the sensor the object is proximate to, or whether multiple objects are proximate to the sensor. For example, the sensors could discern whether one finger (e.g., a thumb) or several fingers (e.g., the pointer, middle, and index fingers) are in contact with the sensor.

The mobile device 400 can be rotated or oriented in various ways. Thus, the display screen 410 can also be rotated and oriented in various ways. As described herein, the proximity sensors 420, 422, 424, 426 can be used to detect the orientation of the screen 410, and the device 400 can change the display mode of the device correspondingly so that the content being displayed on the screen 410 can be properly viewed by a user. The proper display mode depends on which edge of the screen is determined to be the top of the screen 410 for purposes of viewing. For example, the content should be displayed in portrait mode if edge 460 (or 466) is determined to be the top of the content displayed on the screen 410. In general, portrait mode is the display mode where the top and bottom of the displayed content correspond with the shorter edges (e.g., either 460 or 466) of the display screen. Likewise, the content should be displayed in landscape mode if edge 462 (or 464) is determined to be the top. In general, landscape mode is the display mode where the top and bottom of the displayed content corresponds with the longer edges (e.g., either 462 or 464) of the display screen.

Although the mobile device 400 is shown to have longer edges 462 and 464 and shorter edges 460 and 466, the display screen can be square in shape (i.e., all edges are approximately the same length), in which case the landscape and portrait modes are indistinguishable. In this case, the mobile device 400 can be configured to switch between four display modes corresponding to 0°, 90°, 180°, and 270° of rotation of the displayed content (e.g., the 0° display mode can indicate that the edge 460 corresponds to the top of the displayed content, the 90° display mode can indicate that the edge 462 corresponds to the top of the displayed content, the 180° display mode can indicate that the edge 466 corresponds to the top of the displayed content, and the 270° display mode can indicate that the edge 464 corresponds to the top of the displayed content). The display mode of the device is based on which of the four edges is determined to be the top edge of the screen. That is, the orientation of the display should be such that the top of the display corresponds to the edge that proximity sensor(s) detect to be the top edge of the device or screen.

Although mobile devices are shown in the figures and described in this application as having a particular shape, this is merely for purposes of illustration. A person of ordinary skill in the art would understand that tools and techniques described herein can be applied to devices of any shape. For example, proximity sensors can be positioned on any shape device (e.g., circular, or any other geometric or polygon shape) so as to detect objects near to one or more of the edges or sides of the device. Further, the display screen may or may not correspond to the shape of the device. For example, the device can be rectangular with a square display, or the device can be circular with a circular or rectangular display.

### Example 6

### Exemplary Embodiments

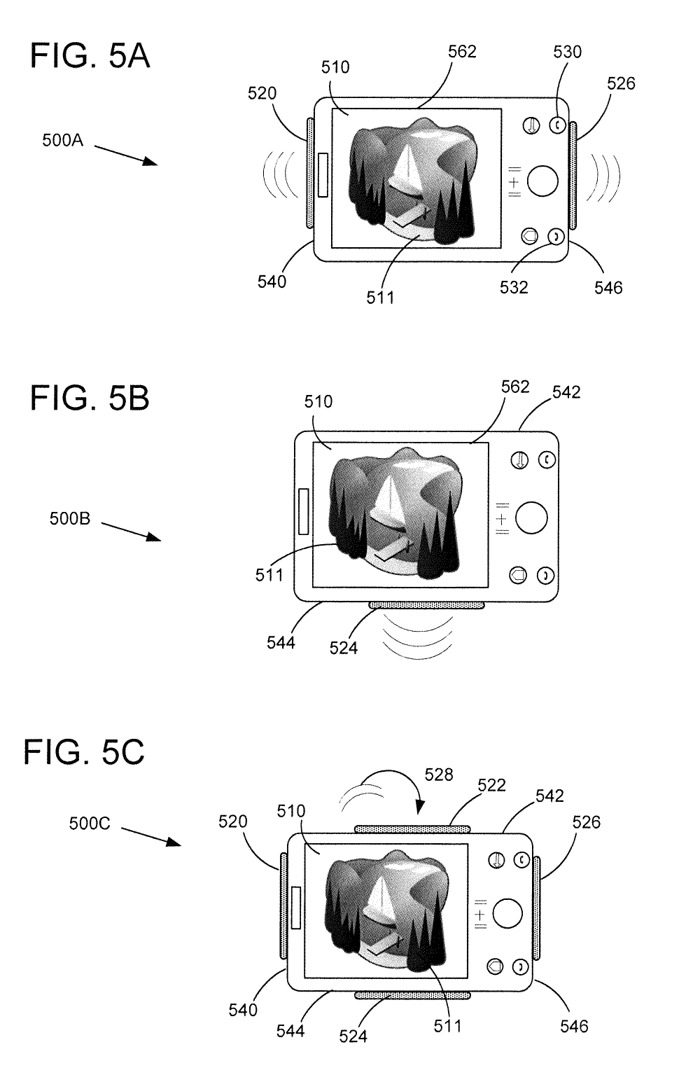

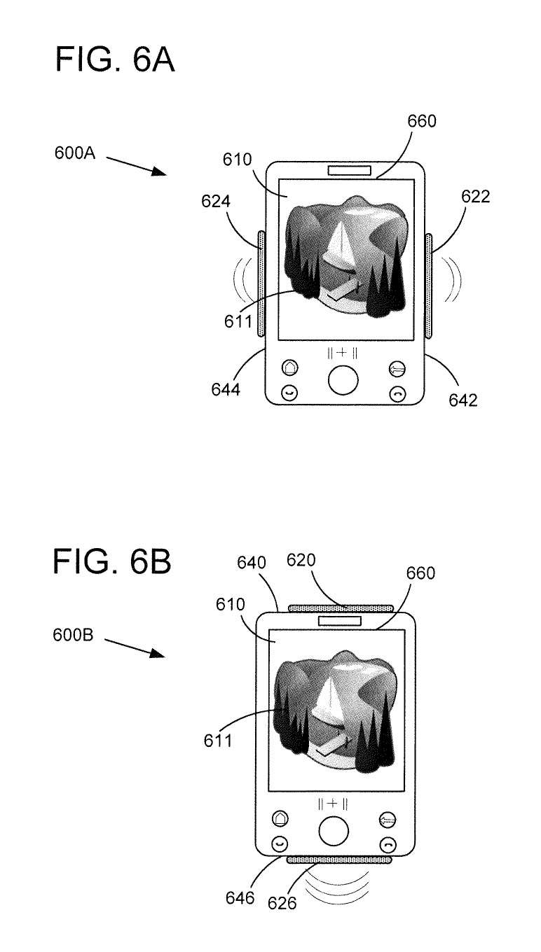

FIGS. 5A-5C and FIGS. 6A-6B illustrate example embodiments of a mobile device configured to detect screen orientation by using one or more proximity sensors. A person of ordinary skill in the art would understand that the illustrated embodiments can be combined to form other embodiments of a mobile device not illustrated in the figures. Referring to FIG. 5A, proximity sensors 520 and 526 of a mobile device 500A are shown to be activated. That is, the sensor 520 is sensing the proximity of one or more objects to edge 540 (the objects being sensed are not shown for purposes of illustration), and the sensor 526 is sensing the proximity of one or more objects to edge 546. For example, the device 500A could be held by a person with one hand contacting the edge 546 and the other hand contacting the edge 540, such that the edge 562 of the screen 510 is considered by the user to correspond to the top of the displayed content 511. This manner of holding the device can be common when videos are being displayed on the screen 510 or games are being played. As a result of the activation of sensors 520 and 526, the mobile device 500A changes the display mode of the screen 510 to be in landscape mode, as shown.

In some implementations of the device 500A, the activation of sensors 520 and 526 can trigger an entertainment mode. Specifically, a function of one or more buttons near to the sensors 520 and 526, such as buttons 530 and 532, can be suppressed, disabled or otherwise changed. For example, any combination of the following can be part of the entertainment mode: the ringer can be disabled, a radio can be turned off, incoming phone calls or text messages can be disallowed, the volume can be turned up or otherwise changed or locked, back and/or search buttons can be disabled or suppressed, and Bluetooth can be disabled for audio and hands-free calls. Further, buttons, such as buttons 530 and 532, can be completely disabled, or the buttons' functions can be suppressed, such as by making it more difficult to trigger the function associated with the buttons. For example, a user may have to press button 532 more than once, press it harder, or press and hold it, in order to trigger its function when the mobile device is in entertainment mode. The user may need to trigger a change in the display mode in order to re-activate the functions suppressed or disabled by the entertainment mode.

Entertainment mode can be useful when a user is playing a game, viewing photos, watching a movie, or engaging in any other activity on his/her mobile device where minimal interruption is desired. Often such activities, like playing a game or watching a movie, occur when the device is held such that sensors 520 and 526 are activated by an individual's hands. It can therefore be desirable to suppress or change functioning of buttons, such as buttons 532 and 530, so that the user does not accidentally press these buttons and interrupt the game or movie.

Referring to FIG. 5B, proximity sensor 524 of a mobile device 500B is shown activated, indicating that one or more objects are proximate to edge 544. For example, the device 500B could be propped up on a person's hand (e.g., the edge 544 could be resting on a person's palm while the back surface of the device is leaning against his/her fingers), or on a stand, table or other object, such that the edge 544 is touching the object it is propped up against. Or, the back surface of device 500B could be resting on a table or other surface and a user could reach out near to or touching the edge 544. In this manner, the screen orientation is such that the edge 562 is considered by the user to correspond to the top of the displayed content 511. As a result of the activation of sensor 524, the mobile device 500B changes the display mode of the screen 510 to be in landscape mode, as shown. In some implementations of the device 500B, the device 500B also includes additional sensors, such as a sensor located on or near edge 542, and the changing of the display mode is based on information from both sensor 524 (activated) and the sensor on edge 542 (not activated), which is indicating that one or more objects are not proximate to the edge 542.

In FIG. 5C, proximity sensor 528 located on the back surface (not shown) of a mobile device 500C is activated, indicating that one or more objects are proximate to the back surface. Further, no other proximity sensors (e.g., such as sensors 520, 522, 524, 526) associated with the device are also activated. For example, the device 500C could be resting on a flat surface, such as a table, chair or other object, or on a person's palm. In that manner, the back surface of the device 500C is in contact with an object, but the edges 540, 542, 544, 546 are not. As a result, the mobile device 500C maintains the display mode that it was in prior to activation of the back proximity sensor 528. In the particular circumstance illustrated in FIG. 5C, the device 500C was in landscape mode prior to activation of the sensor 528, thus the device 500C maintains the landscape mode after activation of the back sensor. For example, the device 500C could have been placed in landscape mode after activation of the sensors 520 and 526 (see, e.g., FIG. 5A).

In some implementations of the device 500C, the device can include proximity sensors in addition to the back sensor 528, such as sensors 520, 522, 524, 526, or combinations thereof. If one or more of these sensors is activated at the same time as the back sensor 528, the device 500C can be configured to ignore the sensor 528. For example, this implementation presumes that activation of a sensor on one or more of the edges 540, 542, 544, 546 is more strongly indicative of the orientation of the screen 510 than activation of the back sensor 528. In another implementation of the device 500C, when the back sensor 528 and one or more of the additional proximity sensors 520, 522, 524, 526 are activated at the same time, the device 500C can ignore all proximity sensors. That is, the device can be configured to utilize data from an accelerometer to determine screen orientation and to control the display mode instead of data from proximity sensors.

In FIG. 6A, proximity sensors 622 and 624 of a mobile device 600A are activated, indicating that one or more objects are proximate to edges 642 and 644, respectively. For example, the device 600A could be held by a person such that his/her hand or fingers are touching both the edge 644 and the edge 642. In this manner, the screen orientation is such that the edge 660 of the screen 610 is considered by the user to correspond to the top of the displayed content 611. As a result of the activation of sensors 622 and 624, the mobile device 600A changes the display mode of the screen 610 to be in portrait mode, as shown.

In FIG. 6B, proximity sensor 626 of a mobile device 600B is activated, indicating that one or more objects are proximate to edge 646. For example, the device 600B could be propped up on a person's hand (e.g., the edge 646 could be resting on a person's palm while the back surface of the device is leaning against his/her fingers), or on a stand, table or other object, such that the edge 646 is touching the object it is propped up against. Or, the back surface of device 600B could be resting on a table or other surface and a user could reach out near to or touching the edge 646. In this manner, the screen orientation is such that the edge 660 is considered by the user to correspond to the top of the displayed content 611. As a result of the activation of sensor 626, the mobile device 600B changes the display mode of the screen 610 to be in portrait mode, as shown. In some implementations of the device 600B, the device 600B also includes a sensor 620, and the changing of the display mode is based on information from both sensors 620 and 626, where proximity sensor 620 is not activated, indicating that one or more objects are not proximate to the edge 640.

### Example 7

### Exemplary Mobile Device

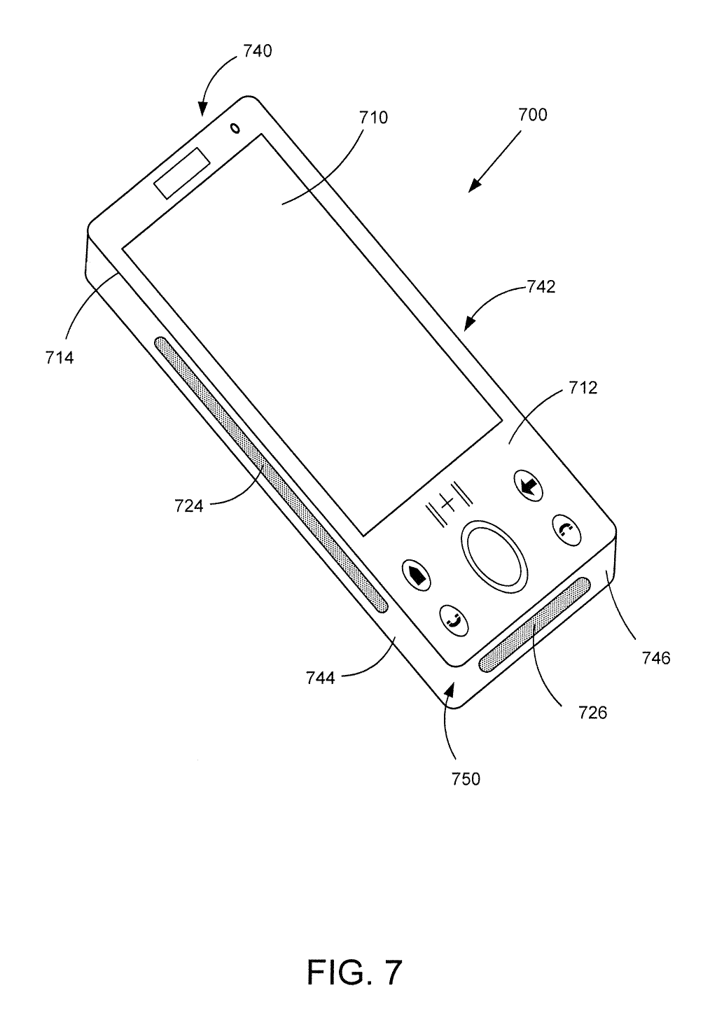

FIG. 7 provides a three-dimensional view an example mobile device 700 capable of implementing tools and techniques described herein. Mobile device 700 has a display screen 710 on its front surface 712 for displaying content (e.g., text or graphics). The mobile device 700 also has proximity sensors 724, 726 positioned near to the perimeter 714 of the front surface 712. Specifically, the proximity sensors 724, 726 are situated on a side surface 750 of the device 700 and configured to detect the proximity of objects to the side surface 750. Although the side surface 750 is shown to be substantially flat and to form an approximate right angle with the front and back surface of the mobile device 700, the side surface 750 can be rounded or otherwise shaped such that the angle formed between the side and the front and/or back surface is less than or greater than 90 degrees.

The device 700 is rectangular in shape with the side surface 750 having four portions: two long sides and two short sides. (However, the device 700 can also be square in shape, in which case all four sides would have approximately the same length.) The sensor 724 is positioned on one of the long-side portions 744 and can be configured to detect the proximity of objects to the long-side portion 744. The sensor 726 is positioned on one of the short-side portions 746 and can be configured to detect the proximity of objects to the short-side portion 746. Although only two proximity sensors 724, 726 are shown, the device 700 can include additional proximity sensors. For example, the device 700 can include an additional proximity sensor on the short-side portion 740 and the long-side portion 742. Further, the mobile device 700 can have fewer proximity sensors, or it can have any combination of the illustrated proximity sensors. For example, the mobile device 700 can have a proximity sensor on its back surface in addition to or instead of other proximity sensors. Further, the mobile device 700 can have only a pair of sensors, such as a pair of short-side portion sensors, a pair of long-side portion sensors, or any other combination.

With reference to FIG. 7, the device 700 can be configured to detect screen orientation and to change the display mode of the screen 710 by using the proximity sensors located on the side surface 750. For example, as shown in Table 1, the display mode can be changed based on which sensors are activated. If two long-side proximity sensors are activated, the device can change to portrait mode. If two short-side proximity sensors are activated, the device can change to landscape mode. However, if only one short-side proximity sensor is activated, the device can change to portrait mode. Likewise, if only one long-side proximity sensor is activated, the device can change to landscape mode. Finally, if only a proximity sensor located on the back is activated, the device can maintain the current display mode.

TABLE 1

| Activated Sensors | Display Mode |
|---|---|
| Two long-side proximity sensors | Portrait |
| One short-side proximity sensor | Portrait |
| Two short-side proximity sensors | Landscape |
| One long-side proximity sensor | Landscape |
| Back proximity sensor | No change |

### Example 8

### Exemplary Method of Detecting Screen Orientation

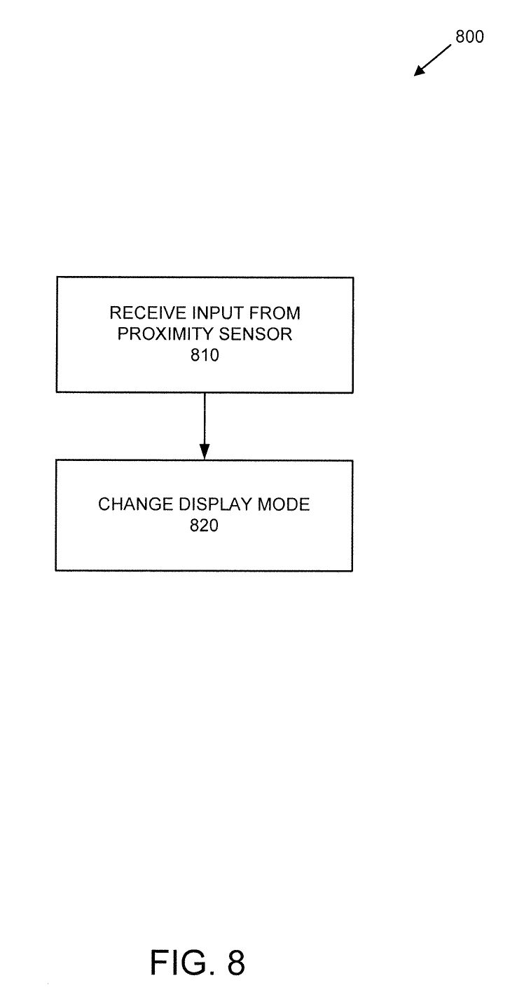

FIG. 8 is a flowchart of an exemplary method 800 of detecting screen orientation using proximity sensors. The method 800 can be implemented using mobile devices and proximity sensors described herein. At 810, input from at least one proximity sensor indicating that one or more objects are proximate to a perimeter of a front surface of a mobile device is received. At 820, a display mode of an electronic display is changed based on the input—the electronic display being positioned on the front surface of the mobile device.

### Example 9

### Exemplary Method of Changing a Display Mode

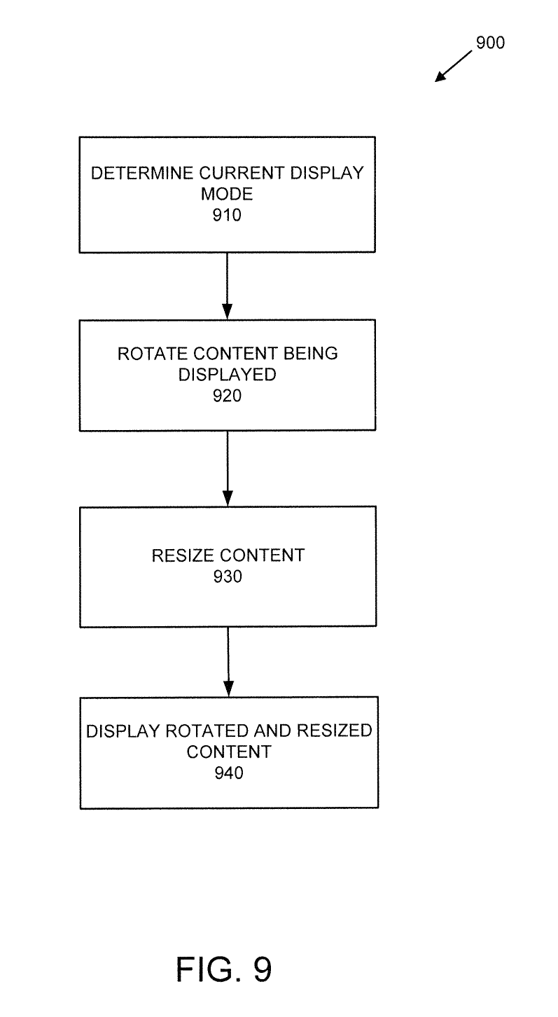

FIG. 9 is a flowchart of an exemplary method 900 of changing a display mode of an electronic display of a mobile device. The method 900 can be implemented using mobile devices and proximity sensors described herein. At 910, a current display mode of the electronic display is determined. For example, the display mode can be determined to be landscape or portrait mode, or the current display mode can be considered a reference mode, such as a 0° display mode. At 920, the content being displayed on the electronic display is then rotated. For example, if the device is switching between the portrait mode and the landscape mode (or vice versa), the content can be rotated 90° or 270°. However, the content can be rotated by any amount. For example, if the device has four display modes, the content can be rotated by 90°, 180°, or 270°. If the device has five display modes, the content can be rotated by 72°, 144°, 216°, or 288°. At 930, the content is optionally resized. For example, the content can be enlarged or reduced in size. At 940, the rotated and (optionally) resized content is displayed.

### Exemplary Advantages

Using proximity sensors in addition to or instead of an accelerometer to detect screen orientation and to control display mode can, in some implementations, have advantages. For example, because proximity sensors can be used to detect how a user is holding the device with a display screen (e.g., by detecting what portions of the device are being held/contacted by the user), proximity sensors can be more accurate at determining the display orientation intended by the user. Users frequently hold a mobile device in the same manner when a particular display mode is desired. By detecting the method of holding the mobile device and by changing the display mode accordingly, unintended changes in display orientation can be avoided. For example, any subsequent device rotation or changes in orientation detected by the accelerometer can be ignored while the device is being held in the same manner. By contrast, in a conventional device using only an accelerometer, the display mode would change based on the subsequent device rotation despite the user maintaining the same manner of holding the device. Such a result would likely be undesired by the user.

### Example of an Implementation Environment

FIG. 10 illustrates a generalized example of a suitable implementation environment 1000 in which described embodiments, techniques, and technologies may be implemented.

In example environment 1000, various types of services (e.g., computing services) are provided by a cloud 1010. For example, the cloud 1010 can comprise a collection of computing devices, which may be located centrally or distributed, that provide cloud-based services to various types of users and devices connected via a network such as the Internet. The implementation environment 1000 can be used in different ways to accomplish computing tasks. For example, some tasks (e.g., processing user input and presenting a user interface) can be performed on local computing devices (e.g., connected devices 1030, 1040, 1050) while other tasks (e.g., storage of data to be used in subsequent processing) can be performed in the cloud 1010.

In example environment 1000, the cloud 1010 provides services for connected devices 1030, 1040, 1050 with a variety of screen capabilities. One or more of the connected devices 1030, 1040, 1050 can be configured as described herein to detect screen orientation by using proximity sensors and to control a display mode based on input from the proximity sensors. Connected device 1030 represents a device with a computer screen 1035 (e.g., a mid-size screen). For example, connected device 1030 could be a personal computer such as desktop computer, laptop, notebook, netbook, or the like. Connected device 1040 represents a device with a mobile device screen 1045 (e.g., a small size screen). For example, connected device 1040 could be a mobile phone, smart phone, personal digital assistant, tablet computer, or the like. Connected device 1050 represents a device with a large screen 1055. For example, connected device 1050 could be a television screen (e.g., a smart television) or another device connected to a television (e.g., a set-top box or gaming console) or the like.

One or more of the connected devices 1030, 1040, 1050 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 1000. For example, the cloud 1010 can provide services for one or more computers (e.g., server computers) without displays.

Services can be provided by the cloud 1010 through service providers 1020, or through other providers of online services (not depicted). For example, cloud services can be customized to the screen size, display capability, and/or touchscreen capability of a particular connected device (e.g., connected devices 1030, 1040, 1050).

In example environment 1000, the cloud 1010 provides the technologies and solutions described herein to the various connected devices 1030, 1040, 1050 using, at least in part, the service providers 1020. For example, the service providers 1020 can provide a centralized solution for various cloud-based services. Further, screen orientation and display mode information based on proximity sensors described herein can be transferred via the cloud 1010 as part of various services. The service providers 1020 can manage service subscriptions for users and/or devices (e.g., for the connected devices 1030, 1040, 1050 and/or their respective users).

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

We claim:

1. A method comprising:
receiving input from at least one proximity sensor indicating that one or more objects are proximate to a perimeter of a front surface of a mobile device; and
changing a display mode of an electronic display based on the input, the electronic display being positioned on the front surface of the mobile device.

2. The method of claim 1, wherein the perimeter has an approximately rectangular shape and comprises four edges that define the approximately rectangular shape, the first and the second edges being approximately equal in length and longer than the third and the fourth edges; and
wherein the input indicates that the one or more objects are proximate to the first edge and to the second edge, and the changing of the display mode of the electronic display comprises placing the electronic display in a portrait mode.

3. The method of claim 1, wherein the perimeter has an approximately rectangular shape and comprises four edges that define the approximately rectangular shape, the first and the second edges being longer than the third and the fourth edges, the third and the fourth edges being approximately equal in length; and
wherein the input indicates that the one or more objects are proximate to the third edge and to the fourth edge, and the changing of the display mode of the electronic display comprises placing the electronic display in a landscape mode.

4. One or more computer storage media storing computer-executable instructions, which, when executed by a computer, cause the computer to perform the method of claim 1.

5. The method of claim 1, wherein the input from the at least one proximity sensor indicating that one or more objects are proximate to the perimeter of the front surface of the mobile device indicates that a person is in physical contact with the mobile device near to the perimeter.

6. The method of claim 1, wherein the perimeter has an approximately rectangular shape and comprises four edges that define the approximately rectangular shape, and the input from the at least one proximity sensor indicates that the one or more objects are in physical contact with at least one of the four edges.

7. The method of claim 1, wherein the mobile device comprises a back surface displaced from and opposite to the front surface, the back surface being joined to the front surface at the perimeter by a side surface, and the input from the at least one proximity sensor indicates that one or more objects are proximate to the side surface.

8. The method of claim 1, wherein the perimeter has an approximately rectangular shape and comprises four edges that define the approximately rectangular shape, the first edge displaced from and opposite to the second edge; and
wherein the input indicates that the one or more objects are proximate to the first edge and not to the second edge, and the changing of the display mode of the electronic display comprises rotating content displayed on the electronic display such that the second edge corresponds to a top edge of the content.

9. The method of claim 8, wherein the first and the second edges are longer than the third and the fourth edges, and the changing of the display mode of the electronic display comprises placing the electronic display in a landscape mode.

10. The method of claim 1, further comprising:
suppressing, disabling, or changing a function of one or more buttons located on the front surface of the mobile device in response to the input indicating that one or more objects are proximate to the perimeter.

11. The method of claim 1, further comprising:
receiving data from an accelerometer indicative of a change in orientation of the mobile device, wherein the changing of the display mode of the electronic display is based on both the input from the at least one proximity sensor and the data from the accelerometer.

12. The method of claim 3, wherein the mobile device comprises a back surface displaced from and opposite to the front surface, the back surface being joined to the front surface at the perimeter, and the method further comprises:
determining that the one or more objects are no longer proximate to the third edge and to the fourth edge;
receiving input from an additional proximity sensor positioned on the back surface indicating that one or more objects are proximate to the back surface of the mobile device; and
indicating that the display mode of the electronic display remain in the landscape mode.

13. A mobile device comprising:
a front surface;
a back surface displaced from and opposed to the front surface;
a side surface contiguous with and intermediate the front surface and the back surface;
one or more proximity sensors positioned on the side surface and configured to detect whether one or more objects is proximate to the one or more proximity sensors; and
an electronic display configured to operate in two or more display modes and further configured to switch between the two or more display modes based on whether the one or more proximity sensors detects the one or more objects, the electronic display being positioned on the front surface.

14. The mobile device of claim 13, wherein the mobile device is a mobile telephone and the two or more display modes comprise a landscape mode and a portrait mode.

15. The mobile device of claim 13, further comprising:
a processor configured to run an operating system to control the electronic display, the operating system being configured to operate the electronic display in the two or more display modes based on whether the one or more proximity sensors detect the one or more objects.

16. The mobile device of claim 13, wherein the side surface has an approximately rectangular shape and comprises four side portions, the first side portion being opposite and spaced from the second side portion, the third side portion being opposite and spaced from the fourth side portion, and each of the first and the second side portions joining the third and the fourth side portions such that the four side portions define the rectangular shape;
wherein the one or more proximity sensors comprises a first proximity sensor located on the first side portion; and
wherein the electronic display is configured to switch between the two or more display modes such that a top edge of content displayed on the electronic display corresponds to the second side portion when the first proximity sensor detects the one or more objects.

17. The mobile device of claim 13, wherein the side surface has an approximately rectangular shape and comprises a first and a second long-side portion and a first and a second short-side portion, the first long-side portion being opposite and spaced from the second long-side portion, the first short-side portion being opposite and spaced from the second short-side portion, and each long-side portion joining the first and the second short-side portions such that the four side portions define the rectangular shape;
wherein the one or more proximity sensors comprises a first and a second proximity sensor, the first proximity sensor being located on the first long-side portion and the second proximity sensor being located on the second long-side portion; and
wherein the two or more display modes comprise a portrait mode and a landscape mode, and the electronic display is configured to switch to the portrait mode when both the first and the second proximity sensors detect the one or more objects.

18. The mobile device of claim 17, further comprising an additional third proximity sensor located on the back surface, wherein the electronic display is further configured to refrain from switching between the two or more display modes when the third proximity sensor detects one or more objects and the first and the second proximity sensor do not detect the one or more objects.

19. The mobile device of claim 17, further comprising an additional third and fourth proximity sensor, the third proximity sensor being located on the first short-side portion and the fourth proximity sensor being located on the second short-side portion, wherein the electronic display is further configured to switch to the landscape mode when both the third and the fourth proximity sensors detect the one or more objects or to switch to the landscape mode when the first proximity sensor detects the one or more objects and the second proximity sensor does not detect the one or more objects.

20. A mobile telephone comprising:
a front surface;
a back surface displaced from and opposed to the front surface;
a side surface connecting the front surface to the back surface, the side surface having an approximately rectangular shape and comprising a first and a second long-side portion and a first and a second short-side portion, the first long-side portion being opposite and spaced from the second long-side portion, the first short-side portion being opposite and spaced from the second short-side portion, and each long-side portion joining the first and the second short-side portions such that the four side portions define the approximately rectangular shape;
a first proximity sensor positioned on the first long-side portion and configured to detect whether one or more objects is proximate to the first long-side portion;
a second proximity sensor positioned on the second long-side portion and configured to detect whether one or more objects is proximate to the second long-side portion;
a third proximity sensor positioned on the first short-side portion and configured to detect whether one or more objects is proximate to the first short-side portion;
a fourth proximity sensor positioned on the second short-side portion and configured to detect whether one or more objects is proximate to the second short-side portion; and
an electronic display positioned on the front surface, the electronic display being configured to operate in a landscape mode when both the third and the fourth proximity sensors detect the one or more objects and to operate in a portrait mode when both the first and the second proximity sensors detect the one or more objects.
